(19) United States
(12) Patent Application Publication
(10) Pub. No.: US 2023/0269810 A1
(43) Pub. Date: Aug. 24, 2023

(54) METHOD FOR RESOURCE UPDATING, ELECTRONIC DEVICE, AND STORAGE MEDIUM

(71) Applicant: BEIJING UNISOC COMMUNICATIONS TECHNOLOGY CO., LTD., Beijing (CN)

(72) Inventor: Hualei WANG, Beijing (CN)

(21) Appl. No.: 18/011,315

(22) PCT Filed: Apr. 13, 2021
(86) PCT No.: PCT/CN2021/086904

§ 371 Date: Dec. 19, 2022

(30) Foreign Application Priority Data
Jun. 19, 2020 (CN) 202010570772.4

(51) Int. Cl. H04W 76/19; H04W 16/28; H04W 72/232; H04W 72/1263

(52) U.S. Cl. CPC H04W 76/19; H04W 16/28; H04W 72/232; H04W 72/1263

(57) ABSTRACT

A method for resource updating is provided. The method includes the following. A terminal device receives a first physical downlink control channel (PDCCH), where the first PDCCH is carried in a beam corresponding to beam information recommended by the terminal device. The terminal device updates within a first duration a first resource based on the beam information, where the first resource includes spatial-domain information of a first channel and/or a first signal.

### CROSS-REFERENCE TO RELATED APPLICATION(S)

This application is a National Stage of International Application No. PCT/CN2021/086904, filed Apr. 13, 2021, which claims priority to Chinese Patent Application No. 202010570772.4, filed Jun. 19, 2020, the entire disclosures of which are hereby incorporated by reference.

### TECHNICAL FIELD

This disclosure relates to the field of communication technology, and particularly to a method for resource updating, an electronic device, and a non-transitory computer-readable storage medium.

### BACKGROUND

In order to solve a problem of narrow beams, a mechanism of beam failure recovery (BFR) process or link recovery process is introduced in new radio (NR). Due to rapid changes of channels, quality of beams received by a terminal will fluctuate. When the terminal detects that the quality of the beams received is lower than a certain threshold and a frequency of detecting the poor-quality beams reaches a preset condition, the BFR process of the terminal is triggered. Specifically, when the terminal detects beam failure, the terminal will transmit a PRACH as a resource updating request in physical random access channel (PRACH) recourse configured through higher-layer signaling, then receive a physical downlink control channel (PDCCH) as a response to the resource updating request from a base station. A search space for the terminal to receive the resource updating response, and a control resource set (CORESET) associated with the search space are configured through the higher-layer signaling, where no other search space will be configured in the CORESET. When the terminal receives the PDCCH as the resource updating response, it is assumed that a demodulation reference signal (DMRS) for PDCCH is quasi co-located (QCLed) with a channel state information reference signal (CSI-RS) with index qnew configured by higher-layer, or is QCLed with a synchronization signal and physical broadcast channel block (SS/PBCH block) (“SSB” for short), where the qnew is an index selected by the terminal from candidate beam indexes configured by high-layer, and the terminal recommend the qnew to a network side implicitly.

### SUMMARY

In a first aspect, a method for resource updating is provided in implementations of the disclosure. The method includes the following. A terminal device receives a first PDCCH, and updates within a first duration a first resource based on beam information, where the first resource includes spatial-domain information of at least one of a first channel or a first signal.

In a second aspect, a terminal device is provided in implementations of the disclosure. The terminal device includes a processor, a memory, a communication interface, and one or more programs. The one or more programs are stored in the memory and configured to be executed by the processor. The one or more programs include instructions for performing some or all operations of the method described in the first aspect.

In a third aspect, a non-transitory computer-readable storage medium is provided in implementations of the disclosure. The computer-readable storage medium stores a computer program for electronic data interchange, where the computer program causes a computer to perform some or all operations of the method described in the first aspect.

### BRIEF DESCRIPTION OF THE DRAWINGS

In order to describe technical solutions in implementations of the disclosure more clearly, the following will give a brief introduction to accompanying drawings used for describing implementations. Apparently, the accompanying drawings hereinafter described are some implementations of the disclosure. Based on these drawings, those of ordinary skill in the art can also obtain other drawings without creative effort.

FIG. 1 is a schematic architectural diagram of a wireless communication system provided in implementations of the disclosure.

FIG. 2 is a schematic flowchart of a method for resource updating provided in implementations of the disclosure.

FIG. 3 is a block diagram illustrating functional units of an apparatus for resource updating provided in implementations of the disclosure.

FIG. 4 is a schematic structural diagram of a terminal device provided in implementations of the disclosure.

### DETAILED DESCRIPTION

The following will describe technical solutions of the disclosure in conjunction with the accompanying figures.

It can be understood that the technical solutions of implementations of the disclosure can be applied to various communication systems, such as a long-term evolution (LTE) system, a 5th generation (5G) mobile communication system (for example, a new radio (NR)), where the 5G mobile communication system includes non-standalone (NSA) 5G mobile communication system and standalone (SA) 5G mobile communication system. The technical solutions provided in the disclosure can also be applied to a communication system that integrates multiple communication technologies, such as a communication system that integrates LTE technologies and NR technologies, or applied to various new future communication systems such as 6th generation (6G) communication systems, 7th generation (7G) communication systems, etc., which is not limited in implementations of the disclosure. The technical solutions of implementations of the disclosure are applicable to different network architectures, including but not limited to a relay network architecture, a dual-link architecture, a vehicle to everything (V2X) architecture, etc.

A transmission and reception point (TRP) involved in implementations of the disclosure may be a base station (BS) (or referred to as a base station device) and is a device deployed in a radio access network (RAN) to provide a wireless communication function. For example, a device for providing a base station function in a 2nd generation (2G) network includes a base transceiver station (BTS) and base station controller (BSC), a device for providing a base station function in a 3rd generation (3G) network includes a node B (NodeB) and radio network controller (RNC), a device for providing a base station function in a 4th generation (4G) network includes an evolved NodeB (eNB), a device for providing a base station function in a wireless local area network (WLAN) is an access point (AP), and a device for providing a base station function in a 5G NR is a next generation NodeB (gNB), and a device for providing a base station function in a new future communication system.

A terminal device involved in implementations of the disclosure includes a device with a wireless communication function. The terminal device may be a mobile phone, a pad, a computer with a wireless transceiver function, a virtual reality (VR) terminal device, an augmented reality (AR) terminal device, a wireless terminal in industrial control, a wireless terminal in self driving, a wireless terminal in remote medical, a wireless terminal in smart grid, a wireless terminal in smart home, etc. The terminal device may also be a handheld device, a vehicle-mounted device, a wearable device, or a computer device with a wireless communication function, or another processing device connected to a wireless modem, or a terminal device in a future 5G network, or a terminal device in a future evolved public land mobile network (PLMN), etc. In different networks, the terminal device may have different names, such as, user equipment (UE), access terminal, user unit, user station, mobile station (MS), remote station, remote terminal, mobile device, user terminal, terminal, wireless communication device, user agent, or user device, cellular phone, cordless phone, session initiation protocol (SIP) phone, wireless local loop (WLL) station, personal digital assistant (PDA), terminal device in a 5G network or a future evolved network, etc., which is not limited in implementations of the disclosure.

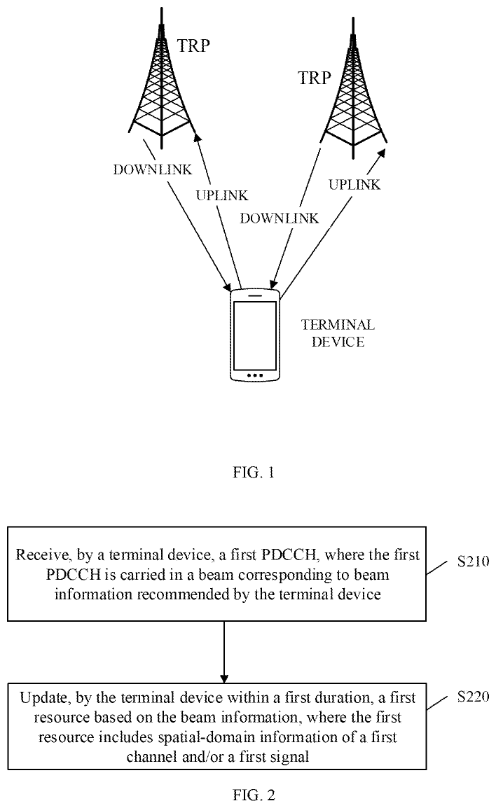

Referring to FIG. 1, FIG. 1 is a schematic diagram of a wireless communication system 100 provided in implementations of the disclosure. As illustrated in FIG. 1, the wireless communication system 100 may include a terminal device and multiple TRPs, where each of the TRPs can communicate with the terminal device. In implementations of the disclosure, one-way communication link from the TRP to the terminal device is defined as downlink (DL), data transmitted in the downlink is called downlink data, and a transmission direction of the downlink data is called downlink direction. One-way communication link from the terminal device to the TRP is defined as uplink (UL), data transmitted in the uplink is called uplink data, and a transmission direction of the uplink data is called uplink direction.

It should be understood that, in implementations of the disclosure, the term “at least one” refers to one or more, the terms “multiple” or “a plurality of” refers to two or more. The term “and/or” describes an association relationship between associated objects, which means that there can be three relationships. For example, A and/or B can mean A alone, both A and B exist, and B alone, where A, B can be singular or plural. In addition, the character “/” generally indicates that the associated objects are in an “or” relationship. The phrase “at least one (term) of the following” or its equivalent refers to any combination of these terms, including any combination of singular or plural terms. For example, at least one of a, b, or c, can denote: a, b, c, a-b, a-c, b-c, or a-b-c, where a, b, c may be single or multiple.

As well, unless the contrary is described, ordinal numerals such as “first” and “second” involved in implementations of the disclosure are used to distinguish multiple objects and not used to limit an order, a timing sequence, a priority, or importance of each of the multiple objects. For example, first message and second message are only used to distinguish different messages, not used to indicate the difference in content, priority, order of transmission, or importance of the two messages.

The terms “network” and “system” in implementations of the disclosure express the same concept, and a communication system is a communication network. The term “connection” in implementations of the disclosure refers to various connection modes such as direct connection or indirect connection, for example, connecting different devices through communication interfaces, which is not limited herein.

The beam failure recovery (BFR) process has been widely studied in Release 15 (Rel-15) and Release 16 (Rel-16). BFR of a special cell (sPCell) is studied in the Rel-15, where the sPCell includes a primary cell (PCell) and a primary secondary cell (PSCell). BFR of a secondary cell (SCell) is studied in the Rel-16.

At present, NR Rel-16 supports multi-transmission and reception point (multi-TRP) transmission, where the terminal is enabled to communicate with multiple TRPs at the same time. Furthermore, NR Rel-16 supports multi-TRP transmission triggered or scheduled by single downlink control information (DCI), and also supports multi-TRP transmission triggered or scheduled by multiple DCI. In a scenario of the multi-TRP transmission triggered or scheduled by the multiple DCI, there are two types of CORESETs, where first CORESETs refer to CORESETs configured with no CORESET pool index or configured with CORESET pool index of 0, and second CORESETs refer to CORESETs configured with CORESET pool index of 1. The first CORESETs and the second CORESETs correspond to different TRPs respectively.

However, the link recovery process in current protocols is for cells, and there is no standardized work for a link recovery process (or beam recovery process) in a multi-TRP scenario. Therefore, it is urgent to support the link recovery process for the TRPs, to realize rapid link recovery for each of the TRPs in the multi-TRP transmission scenario, and especially to update spatial-domain information after the terminal receives a response transmitted by the TRPs.

New radio (NR) Release 16 (Rel-16) supports multi-TRP transmission, that is, supports that a terminal communicates with one or multiple TRPs. However, link recovery process in current protocols is for cells, and there is no standardized work for the link recovery process (or beam recovery process) in a multi-TRP scenario. Therefore, it is urgent to support the link recovery process for the TRPs, to realize rapid link recovery for each of the TRPs in the of the multi-TRP transmission scenario, and especially to update spatial-domain information after the terminal receives a response transmitted by the TRPs.

In order to solve the above problems, a method for resource updating is provided in the disclosure. The terminal device receives a first physical downlink control channel (PDCCH), where the first PDCCH is carried in a beam corresponding to beam information recommended by the terminal device. Within a first duration, the terminal device updates a first resource based on the beam information, where the first resource includes spatial-domain information of a first channel and/or a first signal. In this way, the technical solution of updating spatial-domain information of a channel and/or signal resource is provided in the disclosure. According to the solution after the terminal device receives the first PDCCH as a response, the spatial-domain information of the channel and/or signal resource can be updated according to the beam information recommended by the terminal device, thereby improving system performance.

In order to enable those of skill in the art to better understand technical solutions of the disclosure, the technical solutions in implementations of the disclosure will be described clearly and comprehensively below with reference to the accompanying drawings in implementations of the disclosure. Apparently, implementations described herein are merely some implementations, rather than all implementations, of the disclosure. Based on implementations of the disclosure, all other implementations obtained by those of ordinary skill in the art without creative effort shall fall within the protection scope of the disclosure.

Referring to FIG. 2, FIG. 2 is a schematic flowchart of a method for resource updating provided in implementations of the disclosure. The method for resource updating is applied to the communication system illustrated in FIG. 1, and includes the following as illustrated in FIG. 2.

S210, the terminal device receives a first PDCCH, where the first PDCCH is carried in a beam corresponding to beam information recommended by the terminal device.

The terminal device supports multi-TRP transmission, that is, quasi co-located (QCL) configuration corresponding to multiple TRPs can be included in one downlink control information (DCI). PDCCH configuration consists of two parts, that is, configuration of a control resource set (CORESET) and configuration of a search space set. The CORESET is mainly used to configure resource position where the PDCCH is located, including frequency-domain resource, resource mapping manner, resource element group (REG) bundle size, etc. The Search space set is mainly used to configure a detection period, a detection offset value, a detection time duration, and an aggregation level of the search space set, and numbers of PDCCH candidate sets of each aggregation level, etc.

In a possible implementation, the first PDCCH is scrambled by a cell radio network temporary identifier (C-RNTI) or a modulation and coding scheme cell radio network temporary identifier (MCS-C-RNTI). The terminal device receives the first PDCCH as follows. The terminal device receives a recovery search space ID (RecoverySearchSpaceId), and determines the first PDCCH from a search space corresponding to the RecoverySearchSpaceId.

After transmitting a physical random access channel (PRACH), the terminal device waits for a beam failure recovery (BFR) response transmitted by the TRPs, where the BFR response includes a PDCCH scrambled by the C-RNTI or the MCS-C-RNTI, where the PDCCH is transmitted by the TRP in BFR in a search space provided by higher layer parameter RecoverySearchSpaceId. When the PDCCH scrambled by the C-RNTI or the MCS-C-RNTI is detected in the search space, beam failure recovery request is considered to be transmitted successfully, and BFR process is completed successfully.

It should be noted that, the RecoverySearchSpaceId may be configured by a TRP where the BFR occurs or configured by other TRPs, which is not limited in implementations of the disclosure.

In another possible implementation, the first PDCCH carries DCI, where a hybrid automatic repeat request (HARQ) process number of a physical uplink shared channel (PUSCH) scheduled by the DCI is the same as a HARQ process number of a first PUSCH, and a new data indicator (NDI) field in the first PDCCH indicates that the PUSCH scheduled by the DCI is new data.

The PDCCH includes the NDI field, which is used to identify whether data to be transmitted corresponds to an initial transmission or a retransmission of previous data. In the case of a new data transmission, the NDI field is toggled in an order of 0->1->0->1 . . . . In the case of a retransmission, the NDI field has the same value with a NDI field transmitted initially. Thereby, the TRPs can compare the NDI field with the initially-transmitted NDI field to identify whether data retransmission is performed.

In implementations of the disclosure, when the HARQ process number of the PUSCH scheduled by the DCI carried in the first PDCCH is the same as the HARQ process number of the first PUSCH, and one flipped NDI field value exists in the first PDCCH, that is, a NDI field value of the first PDCCH is opposite to a NDI field value of a previous PDCCH, then the beam failure recovery request is considered to be transmitted successfully, and the BFR process is completed successfully.

S220, within a first duration, the terminal device updates a first resource based on the beam information, where the first resource includes spatial-domain information of a first channel and/or a first signal.

Specifically, after receiving from the TRP a response to the beam failure recovery request, that is, the first PDCCH, and after a certain time, the terminal device updates the spatial-domain information of the first channel and/or the first signal according to beam information of backup beam maintained by the terminal device, where the beam information is carried in the beam failure recovery request.

Optionally, a TRP corresponding to the first channel and/or the first signal is the same as a TRP associated with a reference signal (RS) corresponding to the beam information.

The TRP can configure to the terminal device a corresponding relationship between a transmission configuration Indication (TCI) state and a RS through a radio resource control (RRC) signaling. The TCI state is used as a QCL indication of a demodulation reference signal (DMRS) for a physical downlink shared channel (PDSCH) or a QCL indication of a DMRS for the PDCCH, that is, indicating a downlink beam used for the PDCCH or the PDSCH. Each TCI state corresponds to one or more RS sets, where each of the RS sets includes multiple RS resource. Each of the RS sets is in a QCL relationship with one DMRS port group, for example, one TRP uses one DMRS port group, the DMRS port group is QCLed with one RS set. Specifically, when the TCI state is used as the QCL indication for the PDCCH, one TCI state is informed to indicate one RS set through RRC signaling (or RRC) and medium access control (MAC) control element (CE), where the RS set is QCLed with a DMRS port for the PDCCH. Thereby, according to the TCI state, the terminal device can know which receive (Rx) beam should be used to receive the PDCCH.

In implementations of the disclosure, after receiving the first PDCCH transmitted by the TRPs, the terminal device only updates spatial-domain information of a channel and/or a signal of a TRP associated with the RS corresponding to the beam information, to realize an effective updating of spatial-domain information of a physical channel and/or a signal and avoid updating a physical channel and/or a signal of another TRP. In this way, system performance can be improved.

Optionally, the first channel includes at least one of: a physical uplink control channel (PUCCH), a PDSCH, a PUSCH, first CORESETs, or CORESET #0, the first CORESETs being CORESETs corresponding to a secondary cell (Scell) where a beam failure occurs.

Specifically, the first CORESETs are all CORESETs on a Scell indicated in MAC CE carrying Scell beam failure information. The CORESET #0 is a CORESET with index number of 0 on the Scell and/or a primary cell (PCell). After receiving the first PDCCH, the terminal device can update at least one of: a PUCCH, a PDSCH, a PUSCH, first CORESETs, or CORESET #0 of the TRP associated with the RS corresponding to the beam information.

Optionally, the first signal may include a sounding reference signal (SRS), and SRS configuration is used for a codebook or a non-codebook.

The SRS configuration is used for at least two of: beam management, antenna switching, codebook-based transmission, or non-codebook-based transmission. In implementations of the disclosure, after the BFR occurs, the terminal device can update the SRS based on the beam information, where the SRS configuration is used for codebook-based transmission, or non-codebook-based transmission.

Optionally, the first duration is a duration from a symbol at a preset position after a last symbol of the first PDCCH to a time at which the first resource is configured or activated.

Specifically, the first duration may be a duration from the symbol at the preset position after the last symbol of the first PDCCH received by the terminal device to a time at which part or all of the first resource is configured, or the first duration may be a duration from the symbol at the preset position after the last symbol of the first PDCCH received by the terminal device to a time at which part or all of the first resource is activated. Reconfiguring or reactivating part of the first resource can mean that, the TRPs reconfigures or reactivates any one or more of: spatial-domain information of the PUCCH, the PDSCH, the PUSCH, the first CORESETs, the CORESET #0, or the SRS.

Furthermore, the preset position may be predesigned by a designer, or may be specified in a protocol. For example, the preset position may be 12, 16, 18, 24, 28, 30, 32, etc., which is not limited in implementations of the disclosure.

It can be seen that, the method for resource updating is provided in the disclosure. The terminal device receives the first PDCCH, where the first PDCCH is carried in the beam corresponding to the beam information recommended by the terminal device. Within the first duration, the terminal device updates the first resource based on the beam information, where the first resource includes the spatial-domain information of the first channel and/or the first signal. In this way, the technical solution of updating the spatial-domain information of the channel and/or signal resource is provided in the disclosure. According to the solution after the terminal device receives the first PDCCH as the response, the spatial-domain information of the channel and/or signal resource can be updated according to the beam information recommended by the terminal device, thereby improving system performance.

The above technical solutions of implementations of the disclosure are mainly described from the viewpoint of execution of the method. It can be understood that, in order to implement the above functions, an electronic equipment includes hardware structures and/or software modules corresponding to the respective functions. Those of skill in the art should readily recognize that, in combination with the exemplary units and scheme steps or operations described in implementations provided in the specification herein, the disclosure can be implemented in hardware or a combination of hardware and computer software. Whether a function is implemented by way of hardware or computer software driving hardware depends on the particular application and design constraints of the technical solutions. Those of skill in the art may use different methods to implement the described functions for each particular application, but such implementations should not be considered as beyond the scope of the disclosure.

In implementations of the disclosure, functional units may be divided for the electronic equipment in accordance with the above method examples. For example, functional units may be divided according to corresponding functions, and two or more functions may be integrated into one processing unit. The above-mentioned integrated unit can be implemented in the form of hardware or software functional units. It should be noted that the division of units in implementations of the disclosure is schematic and is merely a logical function division, there may be other division manners in actual implementation.

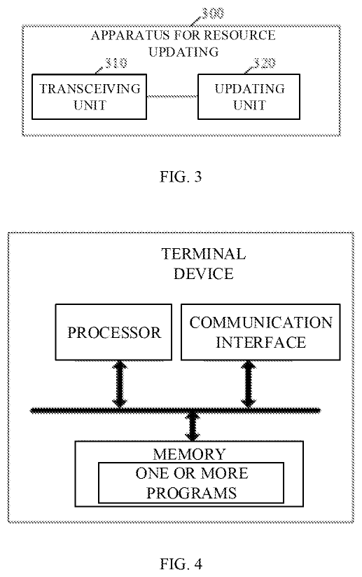

Referring to FIG. 3, FIG. 3 is a block diagram illustrating functional units of an apparatus 300 for resource updating provided in implementations of the disclosure. The apparatus 300 for resource updating is applied to a terminal device, and includes a transceiving unit 310 and an updating unit 320. The transceiving unit 310 is configured to receive a first PDCCH, where the first PDCCH is carried in a beam corresponding to beam information recommended by the terminal device. The updating unit 320 is configured to update within a first duration a first resource based on the beam information, where the first resource includes spatial-domain information of a first channel and/or a first signal.

In a possible implementation of the disclosure, a TRP corresponding to the first channel and/or the first signal is the same as a TRP associated with a RS corresponding to the beam information.

In a possible implementation of the disclosure, the first channel includes at least one of: a PUCCH, a PDSCH, a PUSCH, first CORESETs, or CORESET #0, the first CORESETs being CORESETs corresponding to a Scell where a beam failure occurs.

In a possible implementation of the disclosure, the first signal includes a SRS, and SRS configuration is used for a codebook or a non-codebook.

In a possible implementation of the disclosure, the first PDCCH is scrambled by a C-RNTI or a MCS-C-RNTI. The transceiving unit 310 is specifically configured to receive a Recovery SearchSpaceId, and determine the first PDCCH from a search space corresponding to the RecoverySearchSpaceId.

In a possible implementation of the disclosure, the first PDCCH carries DCI, where a HARQ process number of a PUSCH scheduled by the DCI is the same as a HARQ process number of a first PUSCH, and a NDI field in the first PDCCH indicates that the PUSCH scheduled by the DCI is new data.

In a possible implementation of the disclosure, the first duration is a duration from a symbol at a preset position after a last symbol of the first PDCCH to a time at which the first resource is configured or activated.

It can be understood that, functions of each program module of the apparatus for resource updating in implementations of the disclosure can be specifically implemented according to the methods in the above method implementations, for the specific implementation process, reference can be made to related descriptions of the above method implementations, which will not be repeated herein.

Referring to FIG. 4, FIG. 4 is a schematic structural diagram of a terminal device provided in implementations of the disclosure. The terminal device includes one or more processors, one or more memories, one or more communication interfaces, and one or more programs. The one or more programs are stored in the one or more memories and configured to be executed by the one or more processors. The one or more programs include instructions for performing the following. A first PDCCH is received, where the first PDCCH is carried in a beam corresponding to beam information recommended by the terminal device. A first resource is updated within a first duration based on the beam information, where the first resource includes spatial-domain information of a first channel and/or a first signal.

In a possible implementation of the disclosure, a TRP corresponding to the first channel and/or the first signal is the same as a TRP associated with a RS corresponding to the beam information.

In a possible implementation of the disclosure, the first channel includes at least one of: a PUCCH, a PDSCH, a PUSCH, first CORESETs, or CORESET #0, the first CORESETs being CORESETs corresponding to a Scell where a beam failure occurs.

In a possible implementation of the disclosure, the first signal includes a SRS, and SRS configuration is used for a codebook or a non-codebook.

In a possible implementation of the disclosure, the first PDCCH is scrambled by a C-RNTI or a MCS-C-RNTI. In terms of receiving the first PDCCH, the one or more programs include instructions for further performing the following. A RecoverySearchSpaceId is received, and the first PDCCH from a search space corresponding to the RecoverySearchSpaceId is determined.

In a possible implementation of the disclosure, the first PDCCH carries DCI, where a HARQ process number of a PUSCH scheduled by the DCI is the same as a HARQ process number of a first PUSCH, and a NDI field in the first PDCCH indicates that the PUSCH scheduled by the DCI is new data.

In a possible implementation of the disclosure, the first duration is a duration from a symbol at a preset position after a last symbol of the first PDCCH to a time at which the first resource is configured or activated.

It should be noted that, for the specific implementation process of implementations of the disclosure, reference may be made to the specific implementation process described in the above method implementations, which will not be repeated herein.

A computer storage medium is further provided in implementations of the disclosure. The computer storage medium stores a computer program for electronic data interchange, where the computer program causes a computer to perform some or all operations of any of the method described in the above method implementations.

A computer program product is further provided in implementations of the disclosure. The computer program product includes a non-transitory computer-readable storage medium storing a computer program. The computer program is operable to cause a computer to perform some or all operations of any of the method described in the above method implementations. The computer program product may be a software installation package.

A method and an apparatus for resource updating are provided in implementations of the disclosure. As such, spatial-domain information of a channel and/or signal resource can be updated after a terminal device receives a first physical downlink control channel (PDCCH) transmitted by a transmission and reception point (TRP), thereby improving system performance.

In a first aspect, a method for resource updating is provided in implementations of the disclosure. The method includes the following. A terminal device receives a first PDCCH, and updates within a first duration a first resource based on beam information, where the first resource includes spatial-domain information of a first channel and/or a first signal.

In a second aspect, an apparatus for resource updating is provided in implementations of the disclosure. The apparatus includes a transceiving unit and an updating unit. The transceiving unit is configured to receive a first PDCCH. The updating unit is configured to update within a first duration a first resource based on beam information, where the first resource includes spatial-domain information of a first channel and/or a first signal.

In a third aspect, a terminal device is provided in implementations of the disclosure. The terminal device includes a processor, a memory, a communication interface, and one or more programs. The one or more programs are stored in the memory and configured to be executed by the processor. The one or more programs include instructions for performing some or all operations of the method described in the first aspect.

In a fourth aspect, a computer-readable storage medium is provided in implementations of the disclosure. The computer-readable storage medium stores a computer program for electronic data interchange, where the computer program causes a computer to perform some or all operations of the method described in the first aspect.

In a fifth aspect, a computer program product is provided in implementations of the disclosure. The computer program product includes a non-transitory computer-readable storage medium storing a computer program. The computer program is operable to cause a computer to perform some or all operations of the method described in the first aspect. The computer program product may be a software installation package.

It can be seen that, in implementations of the disclosure, the terminal device receives the first PDCCH, and updates within the first duration the first resource based on the beam information, where the first resource includes the spatial-domain information of the first channel and/or the first signal. In this way, the technical solution of updating the spatial-domain information of the channel and/or signal resource is provided in the disclosure. According to the solution, after the terminal device receives the first PDCCH as a response, the spatial-domain information of the channel and/or signal resource can be updated according to the beam information recommended by the terminal device, thereby improving system performance.

It should be noted that, for the sake of simplicity, the above method implementations are described as a series of action combinations, however, it will be appreciated by those skilled in the art that the disclosure is not limited by the sequence of actions described. According to the disclosure, certain steps or operations may be performed in other order or simultaneously. Besides, it will be appreciated by those skilled in the art that implementations described in the specification are exemplary implementations and the actions and modules involved are not necessarily essential to the disclosure.

In the above implementations, the description of each implementation has its own emphasis. For the parts not described in detail in one implementation, reference may be made to related descriptions in other implementations.

It will be appreciated that the apparatuses disclosed in implementations provided in the disclosure may also be implemented in various other manners. For example, the above apparatus implementations are merely illustrative, e.g., the division of units is only a division of logical functions, and other manners of division may also available in practice, e.g., multiple units or assemblies may be combined or may be integrated into another system, or some features may be ignored or omitted. In other respects, the coupling or direct coupling or communication connection as illustrated or discussed may be an indirect coupling or communication connection through some interface, device or unit, and may be electrical, or otherwise.

Separated units as illustrated may or may not be physically separated. Components displayed as units may or may not be physical units, and may reside at one location or may be distributed to multiple networked units. Some or all of the units may be selectively adopted according to practical needs to achieve desired objectives of implementations of the disclosure.

In addition, the functional units in various implementations of the disclosure may be integrated into one processing unit, or each unit may be physically present, or two or more units may be integrated into one unit. The above-mentioned integrated unit can be implemented in the form of hardware or a software function unit.

The integrated unit may be stored in a computer readable memory when it is implemented in the form of a software functional unit and is sold or used as a separate product. Based on such understanding, the technical solutions of the disclosure essentially, or the part of the technical solutions that contributes to the related art, or all or part of the technical solutions, may be embodied in the form of a software product which is stored in a memory and includes instructions for causing a computer device (which may be a personal computer, a server, or a TRP and the like) to perform all or part of the steps or operations described in the various implementations of the disclosure. The memory includes various medium capable of storing program codes, such as a universal serial bus (USB) flash disk, a read-only memory (ROM), a random access memory (RAM), a removable hard disk, disk, compact disc (CD), or the like.

It will be understood by those of ordinary skill in the art that all or part of the steps or operations of the various methods in implementations described above may be accomplished by means of a program to instruct associated hardware, the program may be stored in a computer readable storage, which may include a flash memory, a ROM, a RAM, disk or CD, and so on.

Implementations of the disclosure are described in detail above. Some examples are used herein to illustrate the principle and implementation manners of the disclosure. The description of the above implementations is only used to help understand the method and core idea of the disclosure. Meanwhile, for those of ordinary skill in the art, according to the idea of the disclosure, there will be changes in the implementation manner and the application scope. In summary, contents of this specification should not be construed as a limitation on the disclosure.

1. A method for resource updating, comprising:
receiving, by a terminal device, a first physical downlink control channel (PDCCH);
updating, by the terminal device within a first duration, a first resource based on beam information, the first resource comprising spatial-domain information of at least one of a first channel or a first signal.

2. The method of claim 1, wherein a transmission and reception point (TRP) corresponding to at least one of the first channel or the first signal is the same as a TRP associated with a reference signal (RS) corresponding to the beam information.

3. The method of claim 1, wherein the first channel comprises at least one of: a physical uplink control channel (PUCCH), a physical downlink shared channel (PDSCH), a physical uplink shared channel (PUSCH), first control resource sets (CORESETs), or CORESET #0, the first CORESETs being CORESETs corresponding to a secondary cell (Scell) where a beam failure occurs.

4. The method of claim 1, wherein the first signal comprises a sounding reference signal (SRS), and SRS configuration is used for a codebook or a non-codebook.

5. The method of claim 1, wherein the first PDCCH is scrambled by a cell radio network temporary identifier (C-RNTI) or a modulation and coding scheme cell radio network temporary identifier (MCS-C-RNTI), and receiving the first PDCCH by the terminal device comprises:
receiving, by the terminal device, a RecoverySearchSpaceId and determining the first PDCCH from a search space corresponding to the RecoverySearchSpaceId.

6. The method of claim 1, wherein the first PDCCH carries downlink control information (DCI), a hybrid automatic repeat request (HARQ) process number of a PUSCH scheduled by the DCI is the same as a HARQ process number of a first PUSCH, and a new data indicator (NDI) field in the first PDCCH indicates that the PUSCH scheduled by the DCI is new data.

7. The method of claim 5, wherein the first duration is a duration from a symbol at a preset position after a last symbol of the first PDCCH to a time the first resource is configured or activated.

8. (canceled)

9. A terminal device, comprising:
a processor;
a memory;
a communication interface; and
one or more programs stored in the memory and configured to be executed by the processor, the one or more programs comprising instructions for:
receiving a first physical downlink control channel (PDCCH);
updating, within a first duration, a first resource based on beam information, the first resource comprising spatial-domain information of at least one of a first channel or a first signal.

10. A non-transitory computer-readable storage medium storing a computer program for electronic data interchange, wherein the computer program is executable by a computer to cause the computer to:
receive a first physical downlink control channel (PDCCH);
update, within a first duration, a first resource based on beam information, the first resource comprising spatial-domain information of at least one of a first channel or a first signal.

11. The terminal device of claim 9, wherein a transmission and reception point (TRP) corresponding to at least one of the first channel or the first signal is the same as a TRP associated with a reference signal (RS) corresponding to the beam information.

12. The terminal device of claim 9, wherein the first channel comprises at least one of: a physical uplink control channel (PUCCH), a physical downlink shared channel (PDSCH), a physical uplink shared channel (PUSCH), first control resource sets (CORESETs), or CORESET #0, the first CORESETs being CORESETs corresponding to a secondary cell (Scell) where a beam failure occurs.

13. The terminal device of claim 9, wherein the first signal comprises a sounding reference signal (SRS), and SRS configuration is used for a codebook or a non-codebook.

14. The terminal device of claim 9, wherein the first PDCCH is scrambled by a cell radio network temporary identifier (C-RNTI) or a modulation and coding scheme cell radio network temporary identifier (MCS-C-RNTI), and receiving the first PDCCH comprises:
receiving a RecoverySearchSpaceId and determining the first PDCCH from a search space corresponding to the RecoverySearchSpaceId.

15. The terminal device of claim 9, wherein the first PDCCH carries downlink control information (DCI), a hybrid automatic repeat request (HARQ) process number of a PUSCH scheduled by the DCI is the same as a HARQ process number of a first PUSCH, and a new data indicator (NDI) field in the first PDCCH indicates that the PUSCH scheduled by the DCI is new data.

16. The terminal device of claim 14, wherein the first duration is a duration from a symbol at a preset position after a last symbol of the first PDCCH to a time the first resource is configured or activated.

17. The non-transitory computer-readable storage medium of claim 10, wherein a transmission and reception point (TRP) corresponding to at least one of the first channel or the first signal is the same as a TRP associated with a reference signal (RS) corresponding to the beam information.

18. The non-transitory computer-readable storage medium of claim 10, wherein the first channel comprises at least one of: a physical uplink control channel (PUCCH), a physical downlink shared channel (PDSCH), a physical uplink shared channel (PUSCH), first control resource sets (CORESETs), or CORESET #0, the first CORESETs being CORESETs corresponding to a secondary cell (Scell) where a beam failure occurs.

19. The non-transitory computer-readable storage medium of claim 10, wherein the first signal comprises a sounding reference signal (SRS), and SRS configuration is used for a codebook or a non-codebook.

20. The non-transitory computer-readable storage medium of claim 10, wherein the first PDCCH is scrambled by a cell radio network temporary identifier (C-RNTI) or a modulation and coding scheme cell radio network temporary identifier (MCS-C-RNTI), and the computer program executable by the computer to receive the first PDCCH is executable by the computer to:
receive a RecoverySearchSpaceId and determining the first PDCCH from a search space corresponding to the RecoverySearchSpaceId.

21. The non-transitory computer-readable storage medium of claim 10, wherein the first PDCCH carries downlink control information (DCI), a hybrid automatic repeat request (HARQ) process number of a PUSCH scheduled by the DCI is the same as a HARQ process number of a first PUSCH, and a new data indicator (NDI) field in the first PDCCH indicates that the PUSCH scheduled by the DCI is new data.
